(19) United States
(12) Patent Application Publication
(10) Pub. No.: US 2026/0360651 A1
(43) Pub. Date: Nov. 12, 2026

(54) PUSH ROD ASSEMBLY AND RELAY

(71) Applicant: Xiamen Hongfa Electric Power Controls Co., Ltd., Xiamen, Fujian (CN)

(72) Inventors: Shuming ZHONG, Xiamen, Fujian (CN); Dapeng FU, Xiamen, Fujian (CN); Wenguang DAI, Xiamen, Fujian (CN); Songsheng CHEN, Xiamen, Fujian (CN)

(73) Assignee: Xiamen Hongfa Electric Power Controls Co., Ltd., Xiamen, Fujian (CN)

(21) Appl. No.: 19/120,812

(22) PCT Filed: Oct. 11, 2023
(86) PCT No.: PCT/CN2023/124040

§ 371 Date: Apr. 14, 2025

(30) Foreign Application Priority Data
Oct. 12, 2022 (CN) 202222688298.2

(51) Int. Cl. H01H 50/64; H01H 50/20; H01H 50/34; H01H 50/42; H01H 50/54; H01H 50/58

(52) U.S. Cl. CPC H01H 50/641; H01H 50/20; H01H 50/34; H01H 50/42; H01H 50/546; H01H 50/58

(57) ABSTRACT

A push rod assembly is applied to a relay and includes a base, a movable member, an elastic member, and a limiting structure. The movable member is movably connected to the base. The elastic member provides an elastic force to cause the movable member to have a tendency to move towards a static contact leading-out terminal of the relay. The limiting structure is connected to the base and the movable member and is configured to restrict a range of movement of the movable member relative to the base. The limiting structure includes a limiting hole and a limiting part engaged with each other, and the limiting part is movably disposed within the limiting hole.

### CROSS-REFERENCE

The present disclosure is the U.S. national phase application of International Application No. PCT/CN2023/124040, filed on Oct. 11, 2023, which claims priority to Chinese Patent Application No. 202222688298.2, filed on Oct. 12, 2022 and titled “Push Rod Assembly and Relay,” the entire content of which is incorporated herein by reference in its entirety.

### TECHNICAL FIELD

The present disclosure relates to the technical field of electronic elements and, more particularly, to a push rod assembly and a relay.

### BACKGROUND

A relay is an electrically controlled element that drives movement of an internal movable member through a magnetic field generated by energizing of an annular coil, in order to close movable and static contacts and achieve a purpose of circuit control.

A push rod assembly includes a base and a movable member, and the movable member is movable relative to the base, so that when the movable member comes into contact with the static contact, the relay completes an over-travel process.

However, in order to adapt to the over-travel process, the movable member in the related art is not simple to be assembled.

### SUMMARY

According to one aspect of the present disclosure, a push rod assembly according to embodiments of the present disclosure is applied to a relay and includes: a base, a movable member, an elastic member, and a limiting structure. The movable member is movably connected to the base. The elastic member provides an elastic force to cause the movable member to have a tendency to move towards a static contact leading-out terminal of the relay. The limiting structure is connected to the base and the movable member and is configured to restrict a range of movement of the movable member relative to the base. The limiting structure includes a limiting hole and a limiting part engaged with each other, and the limiting part is movably disposed within the limiting hole.

According to an embodiment of the present disclosure, one end of the elastic member abuts against the base, and another end of the elastic member abuts against the movable member.

According to an embodiment of the present disclosure, the limiting hole includes a first end and a second end disposed oppositely along a movement direction of the movable member, and an aperture of the limiting hole at the second end is larger than an aperture of the limiting hole at the first end; when the movable member separates from the static contact leading-out terminal, the limiting part is located at the first end of the limiting hole.

According to an embodiment of the present disclosure, an aperture of the limiting hole gradually increases in a direction from the first end to the second end of the limiting hole.

According to an embodiment of the present disclosure, a hole wall of the limiting hole includes a first plane and a second plane disposed oppositely, as well as a first inclined plane and a second inclined plane disposed oppositely; one end of the first inclined plane and one end of the second inclined plane are respectively connected to both ends of the first plane, and another end of the first inclined plane and another end of the second inclined plane are respectively connected to both ends of the second plane.

According to an embodiment of the present disclosure, the limiting part has a first arc-shaped surface configured to achieve limit with the limiting hole when the limiting part is located at the first end of the limiting hole.

According to an embodiment of the present disclosure, the movable member is provided with the limiting part, and the base is provided with the limiting hole.

According to an embodiment of the present disclosure, the movable member includes a movable contact piece and a second magnetizer fixedly connected to the movable contact piece; and the second magnetizer is provided with the limiting part.

According to an embodiment of the present disclosure, the second magnetizer includes: a bottom portion; and a first lateral portion and a second lateral portion, respectively connected to two ends of the bottom portion along a width direction of the movable contact piece, and respectively disposed at two opposite sides of the movable contact piece along the width direction, each of the first lateral portion and the second lateral portion is provided with the limiting part. The base includes a base portion, and a first limiting member and a second limiting member connected to the base portion and arranged oppositely, the first lateral portion is disposed corresponding to the first limiting member, the second lateral portion is disposed corresponding to the second limiting member, and each of the first limiting member and the second limiting member is provided with the limiting hole.

According to an embodiment of the present disclosure, a side surface of the first limiting member facing the first lateral portion and a side surface of the second limiting member facing the second lateral portion each includes a second arc-shaped surface.

According to an embodiment of the present disclosure, the first lateral portion and the second lateral portion are located between the first limiting member and the second limiting member; the limiting parts are respectively integrally provided at and protrudes from a side of the first lateral portion facing away from the second lateral portion and from a side of the second lateral portion facing away from the first lateral portion.

According to an embodiment of the present disclosure, the limiting part is a stamped bud-shaped structure.

According to an embodiment of the present disclosure, the limiting part is a rivet that is riveted to the second magnetizer.

According to an embodiment of the present disclosure, the second magnetizer includes: a bottom portion provided with the limiting part; and a first lateral portion and a second lateral portion, respectively connected to two ends of the bottom portion along a width direction of the movable contact piece, and respectively disposed at two opposite sides of the movable contact piece along the width direction.

According to an embodiment of the present disclosure, the movable member includes: a movable contact piece; a second magnetizer fixedly connected to the movable contact piece; and a fixing member fixedly connected to the second magnetizer and having the limiting part.

According to an embodiment of the present disclosure, the fixing member has a perforation, the elastic member passes through the perforation, one end of the elastic member abuts against the base, and another end of the elastic member abuts against the second magnetizer.

According to an embodiment of the present disclosure, the base has the limiting part; the movable member includes: a movable contact piece, a second magnetizer fixedly connected to the movable contact piece, and a fixing member fixedly connected to the second magnetizer and having the limiting hole.

According to another aspect of the present disclosure, a relay according to embodiments of the present disclosure includes the push rod assembly according to any one of the above embodiments.

According to an embodiment of the present disclosure, the relay further includes: a contact container, the push rod assembly is movable relative to the contact container; and a first magnetizer located within the contact container and fixedly disposed relative to the contact container. The first magnetizer is configured to form a magnetic circuit together with a second magnetizer of the push rod assembly.

### BRIEF DESCRIPTION OF THE DRAWINGS

The above and other features and advantages of the present disclosure will become more apparent by describing in detail exemplary embodiments with reference to the accompanying drawings.

FIG. 1 shows a side view of a push rod assembly according to a first embodiment of the present disclosure.

FIG. 2 shows an exploded view of FIG. 1.

FIG. 3 shows an enlarged partial view of part X in FIG. 1.

FIG. 4 shows a sectional view along line B-B in FIG. 1.

FIG. 5 shows an exploded view of a push rod assembly according to a second embodiment of the present disclosure.

FIG. 6 shows an exploded view of a push rod assembly according to a third embodiment of the present disclosure.

FIG. 7 shows an exploded view of a push rod assembly according to a fourth embodiment of the present disclosure.

FIG. 8 shows an exploded view of a push rod assembly according to a fifth embodiment of the present disclosure.

FIG. 9 shows an exploded view of a push rod assembly according to a sixth embodiment of the present disclosure.

FIG. 10 shows a top view of a relay according to embodiments of the present disclosure.

FIG. 11 shows a perspective view of the relay according to embodiments of the present disclosure from an angle of view.

FIG. 12 shows a perspective view of the relay according to embodiments of the present disclosure from another angle of view.

FIG. 13 shows a schematic view of the relay according to embodiments of the present disclosure with a housing omitted.

FIG. 14 shows a sectional view along line A-A in FIG. 13.

### REFERENCE NUMERALS

10. contact container; 101. contact chamber; 11a. insulating cover; 11. ceramic cover; 12. frame; 13. yoke plate; 131. first through hole; 20. static contact leading-out terminal; 30. connector; 40. first magnetizer; 50. push rod assembly; 51. rod; 52. base; 521. base portion; 522. first limiting member; 523. second limiting member; 524. second arc-shaped surface; 53. movable member; 54. movable contact piece; 55. second magnetizer; 551. Bottom portion; 552. first lateral portion; 553. second lateral portion; 56. elastic member; 57. limiting structure; 571. limiting part; 571a, first arc-shaped surface; 572. limiting hole; 573. first end of limiting hole; 574. second end of limiting hole; 575. first plane; 576. second plane; 577. first inclined plane; 578. second inclined plane; 579. rivet; 58. fixing member; 581. perforation; 1100. housing; 1110. first housing; 1120. second housing; 1200. electromagnetic unit; 1210. coil bobbin; 1220. coil; 1230. static iron core; 1231. second through hole; 1240. movable iron core; 1250. reset member; 1410. metal cover; D1. movement direction; D2. length direction; D3. width direction.

### DETAILED DESCRIPTION

Exemplary embodiments will be now described more fully with reference to the accompanying drawings. However, the exemplary embodiments may be embodied in a variety of forms and should not be construed as being limited to the embodiments set forth herein. Although relative terms such as “above” and “under” are used herein to describe the relationship of one component relative to another component, such terms are used herein only for the sake of convenience, for example, in the directions shown in the figures. It can be understood that if the referenced device is inversed upside down, a component described as “above” will become a component described as “under”. Other relative terms such as “top” and “bottom” also have similar meanings. When a structure is described as “above” another structure, it probably means that the structure is integrally formed on another structure, or the structure is “directly” disposed on another structure, or the structure is “indirectly” disposed on another structure through an additional structure.

Words “one,” “a/an,” “the” and “said” are used herein to indicate the presence of one or more elements/component parts/and others. Terms “including” and “having” have an inclusive meaning which means that there may be additional elements/component parts/and others in addition to the listed elements/component parts/and others. Terms such as “first” and “second” are used herein only as markers and do not limit the number of objects modified after them.

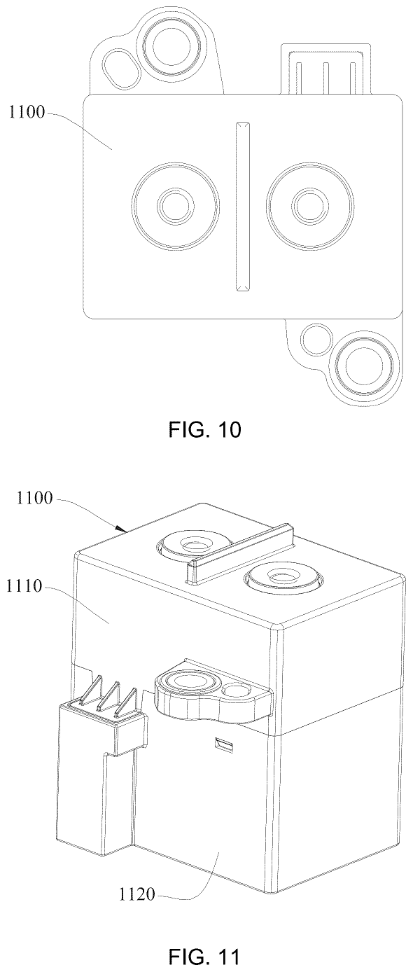

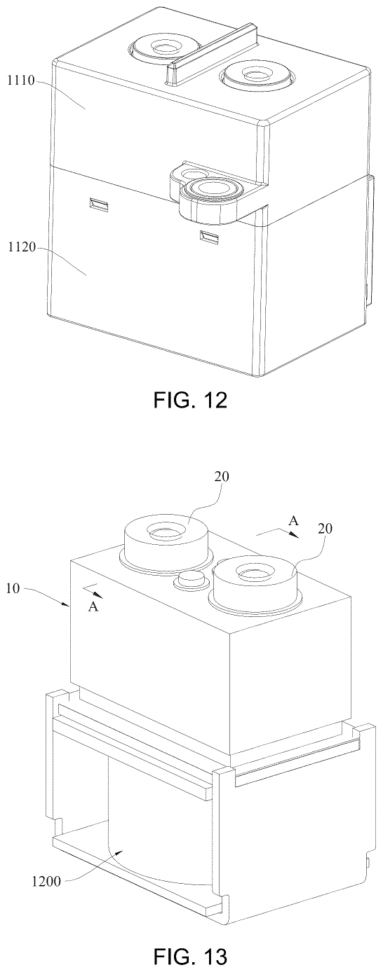

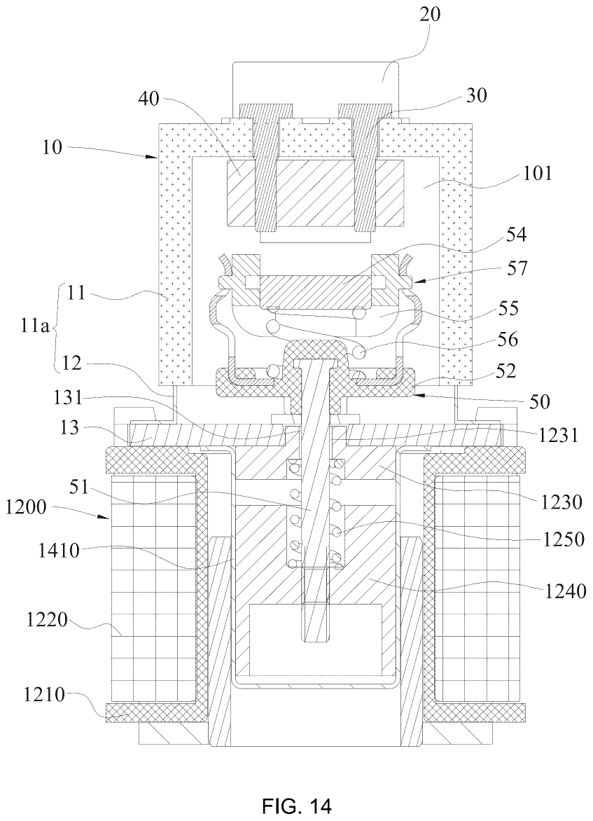

As shown in FIGS. 10-14, FIG. 10 shows a top view of a relay according to embodiments of the present disclosure; FIG. 11 shows a perspective view of the relay according to embodiments of the present disclosure from an angle of view; FIG. 12 shows a perspective view of the relay according to embodiments of the present disclosure from another angle of view; FIG. 13 shows a schematic view of the relay according to embodiments of the present disclosure with a housing omitted; FIG. 14 shows a sectional view along A-A in FIG. 13. The relay according to the embodiments of the present disclosure includes a housing 1100, a contact container 10, a pair of static contact leading-out terminals 20, a first magnetizer 40, a push rod assembly 50, and an electromagnetic unit 1200.

As an example, the housing 1100 includes a first housing 1110 and a second housing 1120, which are snapped together to form a chamber for accommodating the contact container 10, the push rod assembly 50, and the electromagnetic unit 1200.

The contact container 10 has a contact chamber 101, and the pair of static contact leading-out terminals 20 are connected to the contact container 10. One of the pair of static contact leading-out terminals 20 serves as a terminal for current inflow, while the other thereof serves as a terminal for current outflow. Part of the static contact leading-out terminal 20 extends into the contact chamber 101 to come into contact with or separate from a movable contact piece 54 of the push rod assembly 50. Part of the static contact leading-out terminal 20 is exposed to an outer wall surface of the contact container 10.

A bottom of the static contact leading-out terminal 20 serves as a static contact. It can be understood that the static contact may be integrally or separately disposed at the bottom of the static contact leading-out terminal 20.

The contact container 10 includes a yoke plate 13 and an insulating cover 11a. The insulating cover 11a covers a side surface of the yoke plate 13, to form enclose the contact chamber 101 of the contact container 10. The yoke plate 13 has a first through hole 131 in communication with the contact chamber 101, and the push rod assembly 50 movably passes through the first through hole 131.

The insulating cover 11a includes a ceramic cover 11 and a frame 12. The ceramic cover 11 is connected to the yoke plate 13 through the frame 12. The frame 12 may be a metal piece with a ring-shaped structure, such as an iron-nickel alloy. One end of the frame 12 is connected to an open edge of the ceramic cover 11; for example, the end of the frame 12 and the open edge of the ceramic cover 11 are connected by laser welding, brazing, resistance welding, and gluing. The other end of the frame 12 is connected to the yoke plate 13, which may also be achieved by laser welding, brazing, resistance welding, and gluing. The frame 12 is disposed between the ceramic cover 11 and the yoke plate 13 to facilitate the connection between the ceramic cover 11 and the yoke plate 13.

Still referring to FIG. 11, the relay also includes a metal cover 1410, and the metal cover 1410 is connected to a side of the yoke plate 13 facing away from the insulating cover 11a and covers the first through hole 131 in the yoke plate 13. The metal cover 1410 and the yoke plate 13 enclose a chamber for accommodating a static iron core 1230 and a movable iron core 1240 of the electromagnetic unit 1200, which will be described in detail below.

The electromagnetic unit 1200 includes a coil bobbin 1210, a coil 1220, the static iron core 1230, the movable iron core 1240, and a reset member 1250. The coil bobbin 1210 is in the shape of a hollow cylinder and is made of an insulating material. The metal cover 1410 passes through the coil bobbin 1210. The coil 1220 surrounds the coil bobbin 1210. The static iron core 1230 is fixed inside the metal cover 1410, and some of the static iron core 1230 extends into the first through hole 131. The static iron core 1230 has a second through hole 1231 disposed corresponding to a position of the first through hole 131, to allow a rod 51 of the push rod assembly 50 to pass through. The movable iron core 1240 is movably disposed inside the metal cover 1410 and is opposite to the static iron core 1230. The movable iron core 1240 is connected to the rod 51 and is used to be attracted by the static iron core 1230 when the coil 1220 is energized. The movable iron core 1240 and the rod 51 may be connected by screwing, riveting, welding, or other means.

The reset member 1250 is located inside the metal cover 1410 and disposed between the static iron core 1230 and the movable iron core 1240. The reset member 1250 is used to reset the movable iron core 1240 when the coil 1220 is deenergized. The reset member 1250 may be a spring and sleeved over the rod 51.

The first magnetizer 40 is disposed within the contact chamber 101 of the contact container 10 and is fixedly disposed relative to the contact container 10.

As an example, the first magnetizer 40 may be directly connected to the contact container 10 or may be connected to the contact container 10 through a connector 30.

In this embodiment, the first magnetizer 40 is connected to the ceramic cover 11 through the connector 30.

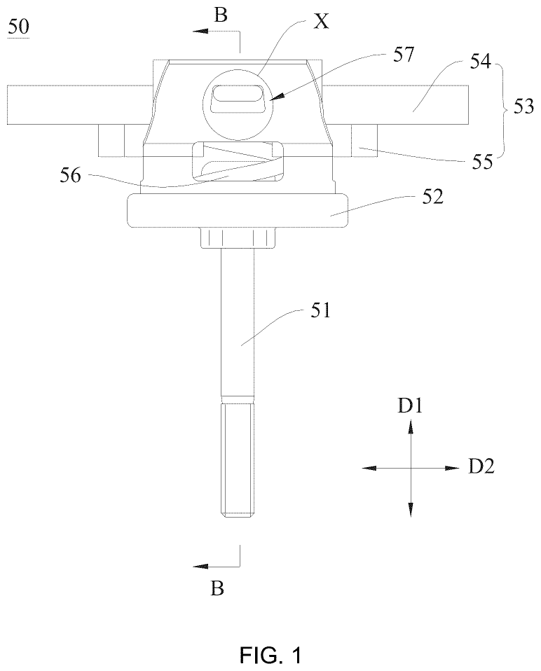

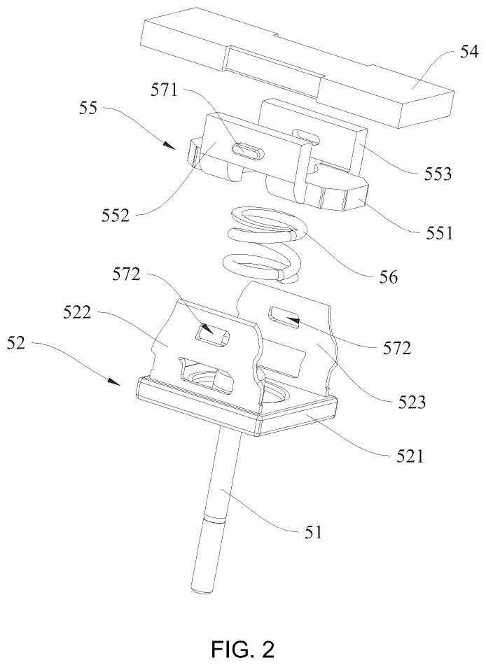

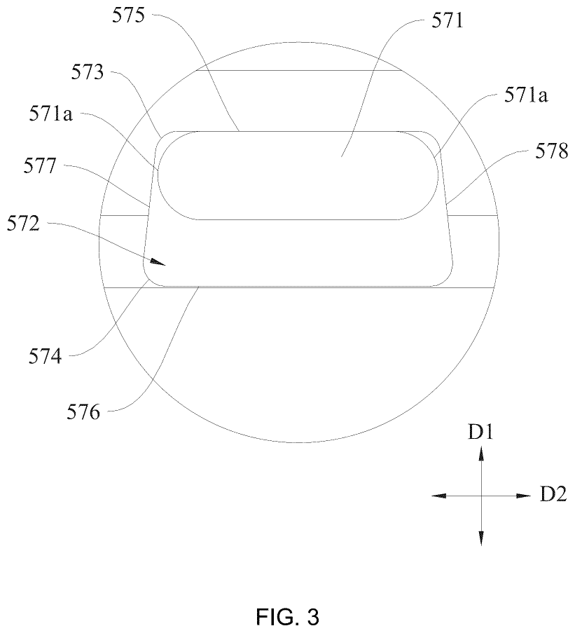

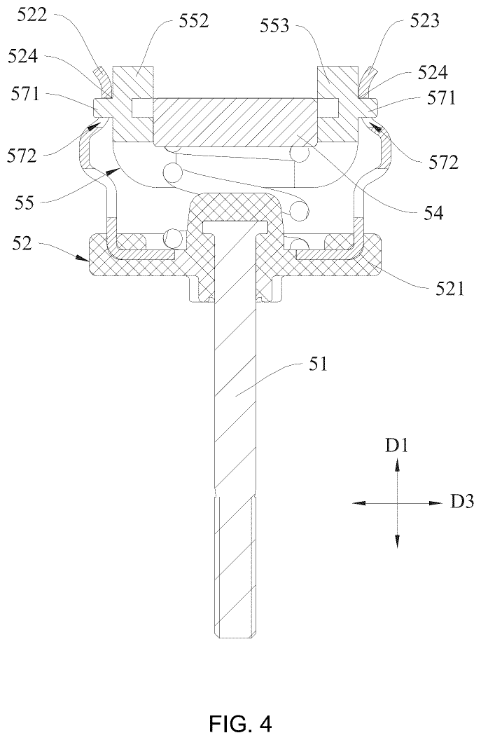

As shown in FIGS. 1-4 and FIG. 11, FIG. 1 shows a side view of a push rod assembly according to a first embodiment of the present disclosure; FIG. 2 shows an exploded view of FIG. 1; FIG. 3 shows an enlarged partial view of X in FIG. 1; FIG. 4 shows a sectional view along B-B in FIG. 1.

The push rod assembly 50 includes the rod 51, a base 52, a movable member 53, an elastic member 56, and a limiting structure 57. The rod 51 movably passes through the first through hole 131 and the second through hole 1231. One end of the rod 51 is connected to the base 52, and the other end of the rod 51 is connected to the movable iron core 1240. When the coil 1220 of the relay is energized, the movable iron core 1240 may drive the rod 51 to move, thereby achieving closure of contacts of the relay. One end of the elastic member 56 abuts against the base 52, and the other end of the elastic member 56 abuts against the movable member 53. The elastic member 56 provides an elastic force to cause the movable member 53 to have a tendency to move towards the static contact leading-out terminal 20 of the relay.

It can be understood that terms “including” and “having” as well as any variations thereof in embodiments of the present disclosure are intended to cover non-exclusive inclusions. For example, a process, method, system, product, or device that includes a series of steps or units is not limited to the listed steps or units, but may optionally include steps or units that are not listed, or may optionally include other steps or components inherent to the process, method, product, or device.

It can be understood that the elastic member 56 may be but is not limited to a spring.

The limiting structure 57 is connected to the base 52 and the movable member 53, and is used to restrict a range of movement of the movable member 53 relative to the base 52. The limiting structure 57 includes a limiting hole 572 and a limiting part 571 engaged with each other. The limiting hole 572 includes a first end 573 and a second end 574 disposed oppositely along a movement direction D1 of the movable member 53. An aperture of the limiting hole 572 at the second end 574 is larger than an aperture of the limiting hole 572 at the first end 573. The limiting part 571 is movable between the first end 573 and the second end 574 of the limiting hole 572.

When the movable member 53 is not in contact with the static contact leading-out terminal 20, the limiting part 571 is located at the first end 573 of the limiting hole 572 under the action of the elastic member 56. When the movable member 53 comes into contact with the static contact leading-out terminal 20 and in a process of completing an over-travel, the limiting part 571 moves from the first end 573 to the second end 574 of the limiting hole 572. Since the aperture of the second end 574 of the limiting hole 572 is larger than the aperture of the limiting hole 572 at the first end 573, the limiting hole 572 presents a structure of “is larger at one end and smaller at the other end”, so that during the over-travel process, a gap between the limiting part 571 and a hole wall of the limiting hole 572 is increased, which may prevent friction and jamming between the limiting part 571 and the hole wall of the limiting hole 572 during the movement of the movable member 53 relative to the base 52. At the same time, the aperture of the first end 573 of the limiting hole 572 is relatively small, which will not affect a limit engagement between the limiting part 571 and the limiting hole 572 in an initial state, and may avoid the movable member 53 from shaking relative to the base 52.

It should be noted that in order to achieve the limit between the movable member 53 and the base 52 in the initial state, the aperture of the first end 573 of the limiting hole 572 should be adapted to the shape of the limiting part 571, so that when the limiting part 571 is located at the first end 573 of the limiting hole 572, the limiting part 571 may achieve the limit with the hole wall of the limiting hole 572.

In this embodiment, the base 52 is directly connected to the movable member 53 through the limiting structure 57, making the assembly between the base 52 and the movable member 53 simpler. Moreover, since there is no other component above the movable member 53, interference between such other component and the first magnetizer 40 during the over-travel process may be avoided.

It can be understood that the limiting hole 572 may be a through hole or a blind hole.

Still referring to FIGS. 1-4, in a direction from the first end 573 to the second end 574 of the limiting hole 572, the aperture of the limiting hole 572 gradually increases. During the over-travel process, when the limiting part 571 moves from the first end 573 to the second end 574 of the limiting hole 572, the gap between the limiting part 571 and the hole wall of the limiting hole 572 gradually increases.

Further, the hole wall of the limiting hole 572 includes a first plane 575 and a second plane 576 disposed oppositely, as well as a first inclined plane 577 and a second inclined plane 578 disposed oppositely. One end of the first inclined plane 577 and one end of the second inclined plane 578 are respectively connected to both ends of the first plane 575; and the other end of the first inclined plane 577 and the other end of the second inclined plane 578 are respectively connected to both ends of the second plane 576.

In this embodiment, the shape of the limiting hole 572 is substantially an isosceles trapezoid, but not limited thereto. For example, the shape of the limiting hole 572 may also be a regular trapezoid, i.e., slopes of the first inclined plane 577 and the second inclined plane 578 are not equal. Alternatively, the shape of the limiting hole 572 may also be a triangle, preferably an isosceles triangle.

Certainly, in other embodiments, the aperture of the limiting hole 572 may not gradually increase along the direction from the first end 573 to the second end 574 of the limiting hole 572. For example, the hole wall of the limiting hole 572 may also include an equal-diameter segment and a widened-diameter segment. For example, from the first end 573 to the second end 574, the hole wall of the limiting hole 572 may sequentially include a widened-diameter segment, an equal-diameter segment, a widened-diameter segment, an equal-diameter segment and etc.

As shown in FIG. 3, the limiting part 571 has a first arc-shaped surface 571a, which is used to achieve limit with the hole wall of the limiting hole 572 when the limiting part 571 is located at the first end 573 of the limiting hole 572.

In this embodiment, an outer wall of the limiting part 571 is designed to include the first arc-shaped surface 571a, so that the first arc-shaped surface 571a is in line contact with the hole wall of the limiting hole 572, and the line contact reduces the friction between the limiting part 571 and the hole wall of the limiting hole 572. When the limiting part 571 and the limiting hole 572 move relative to each other, jamming is less likely to occur.

The base 52 is provided with the limiting hole 572, and the movable member 53 includes the limiting part 571. Certainly, in other embodiments, the limiting hole 572 may also be provided in the movable member 53, and the limiting part 571 may be provided on the base 52.

It can be understood that the movable member 53 includes the movable contact piece 54 and a second magnetizer 55 fixedly connected to the movable contact piece 54. The movable contact piece 54 is used to contact or separate from the static contact leading-out terminal of the relay. The second magnetizer 55 and the first magnetizer 40 are at least partially located at opposite sides of the movable contact piece 54, respectively. The second magnetizer 55 and the first magnetizer 40 may form an anti-short circuit ring electromagnetic structure. The anti-short circuit ring electromagnetic structure may generate a magnetic attraction force between the first magnetizer 40 and the second magnetizer 55 to overcome a repulsion force generated by a short circuit current and prevent the movable contact piece 54 from popping apart from the static contact leading-out terminal.

It can be understood that the first magnetizer 40 may have a linear structure, and the second magnetizer 55 may have a U-shaped structure. The first magnetizer 40 and the second magnetizer 55 may both be made of materials such as iron, cobalt, nickel, and their alloys.

In addition, the first magnetizer 40 may include a plurality of stacked magnetic conductive sheets. The second magnetizer 55 may also include a plurality of stacked magnetic conductive sheets, or the second magnetizer 55 may include a plurality of U-shaped magnetizers arranged side by side.

Certainly, in other embodiments, the movable member 53 may include the movable contact piece 54 but not the second magnetizer 55.

For the convenience of explanation, an example where the movable member 53 includes the movable contact piece 54 and the second magnetizer 55 will be elaborated below, but the present disclosure is not limited thereto.

As shown in FIGS. 1-4, in this embodiment, the base 52 is provided with the limiting hole 572, and the second magnetizer 55 is provided with the limiting part 571. The second magnetizer 55 includes a bottom portion 551, a first lateral portion 552, and a second lateral portion 553. The first lateral portion 552 and the second lateral portion 553 are arranged along a width direction D3 of the movable contact piece 54 and are respectively connected to both ends of the bottom portion 551. The first lateral portion 552 and the second lateral portion 553 are respectively arranged at two opposite sides of the movable contact piece 54 along the width direction D3. Each of the first lateral portion 552 and the second lateral portion 553 is provided with the limiting part 571.

The base 52 includes a base portion 521, and includes a first limiting member 522 and a second limiting member 523 connected to the base portion 521 and arranged oppositely. The first lateral portion 552 is disposed corresponding to the first limiting member 522, and the second lateral portion 553 is disposed corresponding to the second limiting member 523. Each of the first limiting member 522 and the second limiting member 523 is provided with the limiting hole 572.

A side surface of the first limiting member 522 facing the first lateral portion 552 and a side surface of the second limiting member 523 facing the second lateral portion 553 include a second arc-shaped surface 524.

In this embodiment, since the side surface of the first limiting member 522 facing the first lateral portion 552 is designed to include the second arc-shaped surface 524, and the side surface of the second limiting member 523 facing the second lateral portion 553 is designed to include the second arc-shaped surface 524, the two second arc-shaped surfaces 524 are in line contact with the first lateral portion 552 and the second lateral portion 553, respectively, which reduces friction between the first lateral portion 552 and the first limiting member 522, as well as friction between the second lateral portion 553 and the second limiting member 523. When the second magnetizer 55 moves relative to the base 52, jamming is less likely to occur. Moreover, it is possible to avoid generating debris and contaminating the contact chamber of the relay.

The first lateral portion 552 and the second lateral portion 553 are located between the first limiting member 522 and the second limiting member 523. The limiting part 571 is integrally provided at and protrudes from a side of the first lateral portion 552 facing away from the second lateral portion 553 and from a side of the second lateral portion 553 facing away from the first lateral portion 552.

As an example, formation of the limiting part 571 may be achieved by stamping the side of the first lateral portion 552/the second lateral portion 553, and hence the limiting part 571 forms a stamped bud-shaped structure. The specific position of the stamped bud-shaped structure on the first lateral portion 552/the second lateral portion 553 may be flexibly adjusted according to the structure.

In this embodiment, since the two limiting parts 571 protrude from the side of the first lateral portion 552 facing away from the second lateral portion 553, and the side of the second lateral portion 553 facing away from the first lateral portion 552, the first lateral portion 552 and the second lateral portion 553 may be fully in contact with the first limiting member 522 and the second limiting member 523, respectively, thereby ensuring the stability of the second magnetizer 55 and the base 52 during position limiting, and not affecting the magnetic conductivity efficiency.

In an embodiment, the limiting part 571 may be elongated. When the limiting part 571 is located at the first end 573 of the limiting hole 572, a side surface of the elongated shape with a larger area contacts the hole wall of the limiting hole 572. Through the contact between the surface with the larger area of the limiting part 571 and the hole wall of the limiting hole 572, oscillation of the movable contact piece 54 relative to the base 52 in the initial state may be effectively avoided, and the probability of the movable contact piece 54 springing back or rebounding may be reduced.

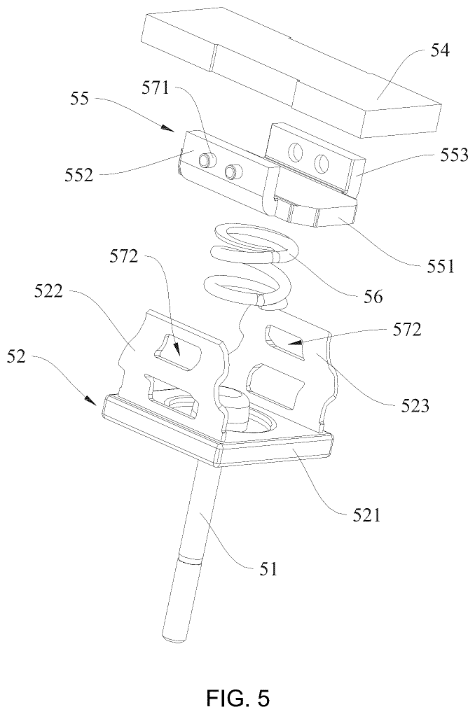

As shown in FIG. 5, FIG. 5 shows an exploded view of the push rod assembly 50 according to a second embodiment of the present disclosure. The similarities between the second embodiment and the above first embodiment will not be repeated, and the differences are as follows.

The limiting part 571 includes two convex hull structures. The two convex hull structures are spaced along a length direction D2 of the movable contact piece 54. The design of the two convex hull structures effectively avoids the oscillation of the movable contact piece 54 relative to the base 52 in the initial state, and reduces the probability of the movable contact piece 54 springing back or rebounding.

It can be understood that the movement direction D1, the length direction D2, and the width direction D3 are perpendicular to each other.

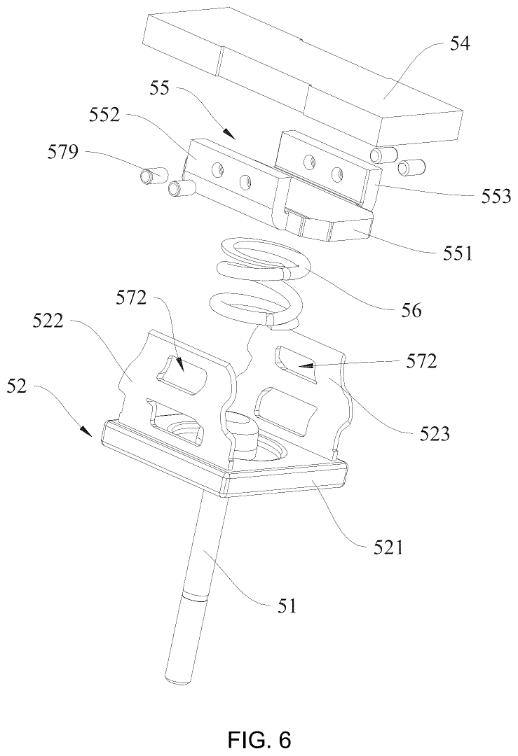

As shown in FIG. 6, FIG. 6 shows an exploded view of the push rod assembly 50 according to a third embodiment of the present disclosure. The similarities between the third embodiment and the above first embodiment will not be repeated, and the differences are as follows.

The limiting part 571 is a rivet 579, which is riveted to the first lateral portion 552 and/or the second lateral portion 553 of the second magnetizer 55.

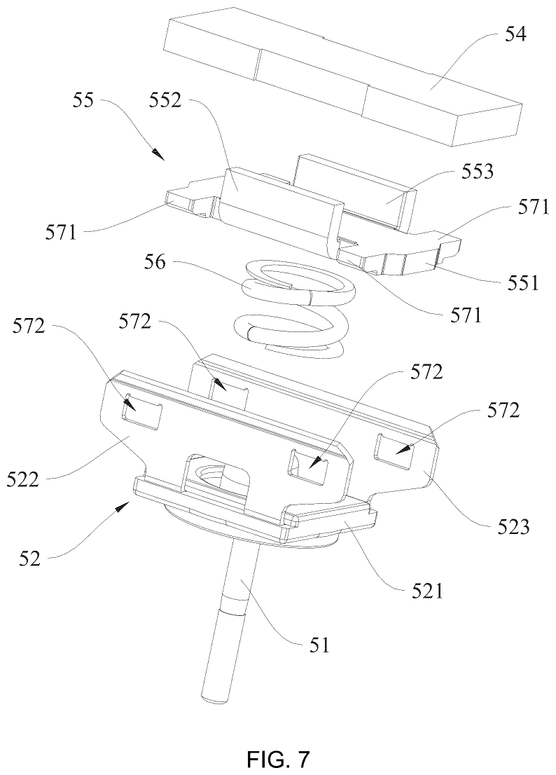

As shown in FIG. 7, FIG. 7 shows an exploded view of the push rod assembly 50 according to a fourth embodiment of the present disclosure. The similarities between the fourth embodiment and the above first embodiment will not be repeated, and the difference lies in that the limiting part 571 is disposed on the bottom portion 551 of the second magnetizer 55.

Specifically, the second magnetizer 55 includes the bottom portion 551, the first lateral portion 552, and the second lateral portion 553. Along the width direction D3 of the movable contact piece 54, the limiting portion 571 is integrally provided at and protrudes from each of two opposite sides of the bottom portion 551. The first lateral portion 552 and the second lateral portion 553 are connected to both ends of the bottom portion 551 along the width direction D3 of the movable contact piece 54, respectively. The first lateral portion 552 and the second lateral portion 553 are respectively disposed at two opposite sides of the movable contact piece 54 along the width direction D3.

The base 52 includes the base portion 521 as well as the first limiting member 522 and the second limiting member 523 connected to the base portion 521 and arranged opposite to each other. Each of the first limiting member 522 and the second limiting member 523 is provided with the limiting hole 572.

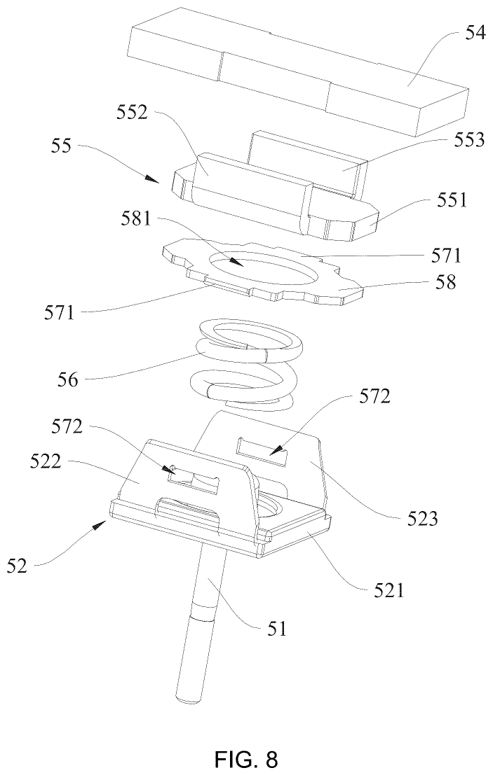

As shown in FIG. 8, FIG. 8 shows an exploded view of the push rod assembly 50 according to a fifth embodiment of the present disclosure. The similarities between the fifth embodiment and the above first embodiment will not be repeated, and the differences are as follows.

The base 52 includes the base portion 521 as well as the first limiting member 522 and the second limiting member 523 connected to the base portion 521 and arranged opposite to each other. Each of the first limiting member 522 and the second limiting member 523 is provided with the limiting hole 572. The movable member 53 also includes a fixing member 58 fixedly connected to the second magnetizer 55, and each of two opposite sides of the fixing member 58 is provided with the limiting part 571.

The first limiting member 522, the second limiting member 523, and the base portion 521 may be integrally injection-molded, but are not limited thereto.

The fixing member 58 has a perforation 581, and the elastic member 56 passes through the perforation 581. Two ends of the elastic member 56 abut against the second magnetizer 55 and the base 52, respectively.

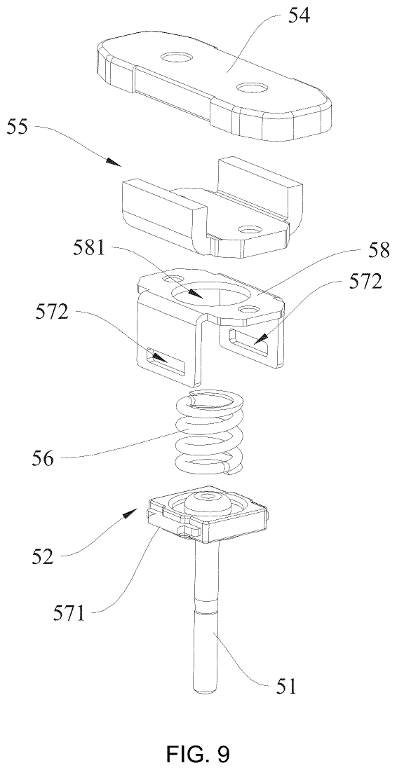

As shown in FIG. 9, FIG. 9 shows an exploded view of the push rod assembly 50 according to a sixth embodiment of the present disclosure. The similarities between the sixth embodiment and the above first embodiment will not be repeated, and the differences are as follows.

The limiting part 571 is disposed at and protrudes from each of the two opposite sides of the base 52 of the push rod assembly 50. The movable member 53 also includes the fixing member 58 fixedly connected to the second magnetizer 55, and the fixing member 58 is provided with the limiting hole 572.

It should be noted that the fixing member 58 has an inverted U-shaped structure, and positions of the first end 573 and the second end 574 of the limiting hole 572 disposed on the fixing member 58 are exactly opposite to those of the limiting holes 572 in the first to fifth embodiments.

Specifically, as shown in FIG. 9, the first end 573 of the limiting hole 572 is located below, while the second end 574 is located above; and the aperture of the limiting hole at the second end 574 is larger than that at the first end 573.

As shown in FIGS. 2 and 5-8, the first end 573 of the limiting hole 572 is located above, while the second end 574 is located below.

The present disclosure has at least the following advantages or beneficial effects.

For the push rod assembly according to embodiments of the present disclosure, the range of movement of the movable member relative to the base is restricted by connecting the movable member with the base through the limiting structure. Since the limiting structure includes a limiting hole and a limiting part engaged with each other, the push rod assembly has a simple structure and is convenient to be assembled.

It can be understood that various embodiments/implementations in the present disclosure may be combined with each other without contradiction, which will not be elaborated here.

It should be understood that the application of the present disclosure is not limit to the detailed structure and arrangement of components provided in this specification. The present disclosure may have other embodiments, and may be implemented and carried out in various ways. The aforementioned variations and modifications fall within the scope of the present disclosure. It should be understood that the present disclosure revealed and defined in this specification may extend to all alternative combinations of two or more individual features that are apparent or mentioned in the text and/or drawings. All of the different combinations form various alternative aspects of the present disclosure. Embodiments described in this specification illustrate the best modes known for carrying out the present disclosure, and will allow those skilled in the art to utilize the present disclosure.

1.: A push rod assembly, applied to a relay, and comprising:
a base;
a movable member movably connected to the base;
an elastic member, providing an elastic force to cause the movable member to have a tendency to move towards a static contact leading-out terminal of the relay; and
a limiting structure, connected to the base and the movable member and configured to restrict a range of movement of the movable member relative to the base, the limiting structure comprising a limiting hole and a limiting part engaged with each other, and the limiting part being movably disposed within the limiting hole.

2-18. (canceled)

19.: The push rod assembly according to claim 1, wherein one end of the elastic member abuts against the base, and another end of the elastic member abuts against the movable member.

20.: The push rod assembly according to claim 1, wherein the limiting hole comprises a first end and a second end disposed oppositely along a movement direction of the movable member, and an aperture of the limiting hole at the second end is larger than an aperture of the limiting hole at the first end;
when the movable member separates from the static contact leading-out terminal, the limiting part is located at the first end of the limiting hole.

21.: The push rod assembly according to claim 20, wherein an aperture of the limiting hole gradually increases in a direction from the first end to the second end of the limiting hole.

22.: The push rod assembly according to claim 21, wherein a hole wall of the limiting hole comprises a first plane and a second plane disposed oppositely, as well as a first inclined plane and a second inclined plane disposed oppositely; one end of the first inclined plane and one end of the second inclined plane are respectively connected to both ends of the first plane, and another end of the first inclined plane and another end of the second inclined plane are respectively connected to both ends of the second plane.

23.: The push rod assembly according to claim 20, wherein the limiting part has a first arc-shaped surface configured to achieve limit with the limiting hole when the limiting part is located at the first end of the limiting hole.

24.: The push rod assembly according to claim 1, wherein the movable member is provided with the limiting part, and the base is provided with the limiting hole.

25.: The push rod assembly according to claim 24, wherein the movable member comprises a movable contact piece and a second magnetizer fixedly connected to the movable contact piece; and the second magnetizer is provided with the limiting part.

26.: The push rod assembly according to claim 25, wherein the second magnetizer comprises:
a bottom portion; and
a first lateral portion and a second lateral portion, respectively connected to two ends of the bottom portion along a width direction of the movable contact piece, and respectively disposed at two opposite sides of the movable contact piece along the width direction, each of the first lateral portion and the second lateral portion is provided with the limiting part,
wherein the base comprises a base portion, and a first limiting member and a second limiting member connected to the base portion and arranged oppositely, the first lateral portion is disposed corresponding to the first limiting member, the second lateral portion is disposed corresponding to the second limiting member, and each of the first limiting member and the second limiting member is provided with the limiting hole.

27.: The push rod assembly according to claim 26, wherein a side surface of the first limiting member facing the first lateral portion and a side surface of the second limiting member facing the second lateral portion each comprises a second arc-shaped surface.

28.: The push rod assembly according to claim 26, wherein the first lateral portion and the second lateral portion are located between the first limiting member and the second limiting member;
the limiting parts are respectively integrally provided at and protrude from a side of the first lateral portion facing away from the second lateral portion and from a side of the second lateral portion facing away from the first lateral portion.

29.: The push rod assembly according to claim 28, wherein the limiting part is a stamped bud-shaped structure.

30.: The push rod assembly according to claim 26, wherein the limiting part is a rivet that is riveted to the second magnetizer.

31.: The push rod assembly according to claim 25, wherein the second magnetizer comprises:
a bottom portion provided with the limiting part; and
a first lateral portion and a second lateral portion, respectively connected to two ends of the bottom portion along a width direction of the movable contact piece, and respectively disposed at two opposite sides of the movable contact piece along the width direction.

32.: The push rod assembly according to claim 24, wherein the movable member comprises:
a movable contact piece;
a second magnetizer fixedly connected to the movable contact piece; and
a fixing member fixedly connected to the second magnetizer and having the limiting part.

33.: The push rod assembly according to claim 32, wherein the fixing member has a perforation, the elastic member passes through the perforation, and one end of the elastic member abuts against the base, and another end of the elastic member abuts against the second magnetizer.

34.: The push rod assembly according to claim 1, wherein the base has the limiting part; and
the movable member comprises:
a movable contact piece;
a second magnetizer fixedly connected to the movable contact piece; and
a fixing member fixedly connected to the second magnetizer and having the limiting hole.

35.: A relay comprising the push rod assembly according to claim 1.

36.: The relay according to claim 35, further comprising:
a contact container, the push rod assembly being movable relative to the contact container; and
a first magnetizer located within the contact container and fixedly disposed relative to the contact container,
wherein the first magnetizer is configured to form a magnetic circuit together with a second magnetizer of the push rod assembly.
